(19) United States
(12) Patent Application Publication
(10) Pub. No.: US 2026/0141177 A1
(43) Pub. Date: May 21, 2026

(54) SYSTEM AND METHOD FOR EXTRACTING ENTITIES AND RELATIONSHIPS FROM RECORDS

(71) Applicant: Ancestry.com Operations Inc., Lehi, UT (US)

(72) Inventors: Gopalkrishna Balkrishna Veni, Lehi, UT (US); Jack Reese, Lindon, UT (US)

(21) Appl. No.: 19/373,139

(22) Filed: Oct. 29, 2025

Related U.S. Application Data
(60) Provisional application No. 63/721,337, filed on Nov. 15, 2024.

(51) Int. Cl. G06F 40/295; G06F 40/131

(52) U.S. Cl. CPC G06F 40/295; G06F 40/131

(57) ABSTRACT

The present disclosure relates to methods, systems, and non-transitory computer-readable media for a unique approach to processing genealogical records. For instance, the disclosed systems can receive a genealogical record in a digital format and transcribe text from the genealogical record to generate machine-readable text. The disclosed systems can process the machine-readable text using a sliding window for in-page entity and relationship extraction. The disclosed systems can also segment each page of the genealogical record to identify and categorize text blocks therefrom. Additionally, the disclosed systems can perform cross-page entity and relation extraction and reconcile entities and relationships extracted from in-page and cross-page extraction. Further, the disclosed systems can generate, from the extracted entities and relationships, family tree data instances representing family relationships between the entities, and associating biographical data with each entity. In some embodiments, the disclosed systems store the generated family tree data instances in a database.

### CROSS-REFERENCE TO RELATED APPLICATIONS

This application claims priority to and the benefit of U.S. Provisional Patent Application No. 63/721,337, filed on Nov. 15, 2024, which is incorporated herein by reference in its entirety.

### FIELD

The disclosed embodiments relate to methods and systems for extracting entities and relationships in a genealogical record to construct a family tree.

### BACKGROUND

Data-inheritance origins may be referred to as origins and describe how data may be inherited from real-world events. Data may be inherited and evolved based on real-world events that are not always recorded or documented. Yet, while the real-world events may not be completely documented, the change and inheritance of those events may be traceable by comparing data strings among data instances. For example, two data instances may be generated independently and individually reflect the status of their respective named entities or events. The data patterns in the data instances may reflect the natures, histories, or characteristics of data inheritance sources such as related or unrelated named entities or events. However, multiple data instances or corresponding named entities or events may be inherited from one or more common sources so that the data instances share some similarities in the data pattern. As such, the nature of inheritance may be revealed by analyzing and comparing the multiple data instances, and sometimes a large number of data instances. Those real-life events that result in shared data strings among data instances may be referred to as data inheritance events, even though those real-life events, at the time of the occurrence, may not involve data or data generation at all. For example, the real-life events may be historical events that occurred before the invention of computers or data but present data instances may still reflect those historical events.

### SUMMARY

Disclosed herein relates to example embodiments that processes genealogical records. The method includes receiving a genealogical record in a digital format. The method includes transcribing text from the genealogical record to generate machine-readable text. The method includes processing the machine-readable text using a sliding window for in-page entity and relationship extraction. The method includes segmenting each page of the family history book to identify and categorize text blocks therefrom. The method includes performing cross-page entity and relation extraction and reconciling entities and relationships extracted from in-page and cross-page extraction. The method includes generating, from the extracted entities and relationships, family tree data instances representing family relationships between the entities, and associating biographical data with each entity. The method includes storing the generated family tree data instances in a database.

In yet another embodiment, a non-transitory computer-readable medium that is configured to store instructions is described. The instructions, when executed by one or more processors, cause the one or more processors to perform a process that includes steps described in the above computer-implemented methods or described in any embodiments of this disclosure. In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. 1 illustrates a diagram of a system environment of an example computing system, in accordance with some embodiments.

FIG. 2 is a block diagram of an architecture of an example computing system, in accordance with some embodiments.

FIG. 3 is a flowchart depicting an example process for extracting entities and relationships in genealogical records, in accordance with some embodiments.

FIG. 4A illustrates a system architecture for extracting entities and relationships from genealogical records, in accordance with some embodiments.

FIG. 4B illustrates another system architecture for extracting entities and relationships from genealogical records, in accordance with some embodiments.

FIG. 4C illustrates yet another system architecture for extracting entities and relationships from genealogical records, in accordance with some embodiments.

FIG. 4D illustrates steps to correct annotated records for training a model, in accordance with some embodiments.

FIG. 5A illustrates images of a genealogical record, in accordance with some embodiments.

FIGS. 5B-5C illustrate family history trees, in accordance with some embodiments.

FIG. 6 is a block diagram of an example computing device, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example System Environment

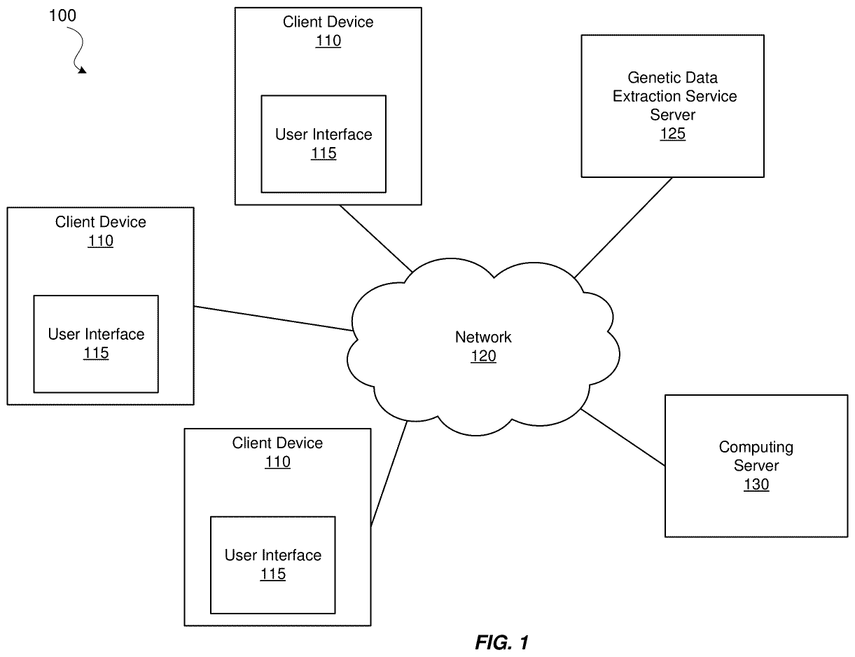

FIG. 1 illustrates a diagram of a system environment 100 of an example computing server 130, in accordance with some embodiments. The system environment 100 shown in FIG. 1 includes one or more client devices 110, a network 120, a genetic data extraction service server 125, and a computing server 130. In various embodiments, the system environment 100 may include fewer or additional components. The system environment 100 may also include different components.

The client devices 110 are one or more computing devices capable of receiving user input as well as transmitting and/or receiving data via a network 120. Example computing devices include desktop computers, laptop computers, personal digital assistants (PDAs), smartphones, tablets, wearable electronic devices (e.g., smartwatches), smart household appliances (e.g., smart televisions, smart speakers, smart home hubs), Internet of Things (IoT) devices or other suitable electronic devices. A client device 110 communicates to other components via the network 120. Users may be customers of the computing server 130 or any individuals who access the system of the computing server 130, such as an online website or a mobile application. In some embodiments, a client device 110 executes an application that launches a graphical user interface (GUI) for a user of the client device 110 to interact with the computing server 130. The GUI may be an example of a user interface 115. A client device 110 may also execute a web browser application to enable interactions between the client device 110 and the computing server 130 via the network 120. In another embodiment, the user interface 115 may take the form of a software application published by the computing server 130 and installed on the user device 110. In yet another embodiment, a client device 110 interacts with the computing server 130 through an application programming interface (API) running on a native operating system of the client device 110, such as IOS or ANDROID.

The network 120 provides connections to the components of the system environment 100 through one or more sub-networks, which may include any combination of local area and/or wide area networks, using both wired and/or wireless communication systems. In some embodiments, a network 120 uses standard communications technologies and/or protocols. For example, a network 120 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 120 may be represented using any suitable format, such as hypertext markup language (HTML) or extensible markup language (XML). In some embodiments, all or some of the communication links of a network 120 may be encrypted using any suitable technique or techniques such as secure sockets layer (SSL), transport layer security (TLS), virtual private networks (VPNs), Internet Protocol security (IPsec), etc. The network 120 also includes links and packet-switching networks such as the Internet.

Individuals, who may be customers of a company operating the computing server 130, provide biological samples for analysis of their genetic data. Individuals may also be referred to as users. In some embodiments, an individual uses a sample collection kit to provide a biological sample (e.g., saliva, blood, hair, tissue) from which genetic data is extracted and determined according to nucleotide processing techniques such as microarray, amplification and/or sequencing. Microarray may include immobilizing probe DNA sequences, onto a solid surface such as a glass slide. Target DNA samples, labeled with fluorescent tags, are then applied to the microarray surface. Through complementary base pairing, the labeled DNA binds to its corresponding probe on the microarray. By detecting the fluorescence emitted by the labeled DNA, genetic data may be extracted. Amplification may include using polymerase chain reaction (PCR) to amplify segments of nucleotide samples. Sequencing may include sequencing of deoxyribonucleic acid (DNA) sequencing, ribonucleic acid (RNA) sequencing, etc. Suitable sequencing techniques may include Sanger sequencing and massively parallel sequencing such as various next-generation sequencing (NGS) techniques including whole genome sequencing, pyrosequencing, sequencing by synthesis, sequencing by ligation, and ion semiconductor sequencing. In some embodiments, a set of SNPs (e.g., 300,000) that are shared between different array platforms (e.g., Illumina OmniExpress Platform and Illumina HumanHap 650Y Platform) may be obtained as genetic data. Genetic data extraction service server 125 receives biological samples from users of the computing server 130. The genetic data extraction service server 125 extracts genetic data from the samples and the data may take the form of a set of SNPs. The genetic data extraction service server 125 generates the genetic data of the individuals based on sequencing or microarray results. The genetic data may include data generated from DNA or RNA and may include base pairs from coding and/or noncoding regions of DNA.

The genetic data may take different forms and include information regarding various biomarkers of an individual. For example, in some embodiments, the genetic data may be the base pair sequence of an individual. The base pair sequence may include the whole genome or a part of the genome such as certain genetic loci of interest. In another embodiment, the genetic data extraction service server 125 may determine genotypes from DNA identification results, for example by identifying genotype values of single nucleotide polymorphisms (SNPs) present within the DNA. The results in this example may include a sequence of genotypes corresponding to various SNP sites. A SNP site may also be referred to as a SNP locus. A genetic locus is a segment of a genetic sequence. A locus can be a single site or a longer stretch. The segment can be a single base long or multiple bases long. In some embodiments, the genetic data extraction service server 125 may perform data pre-processing of the genetic data to convert raw sequences of base pairs to sequences of genotypes at or genotyping data of target SNP sites. Since a typical human genome may differ from a reference human genome at only several million SNP sites (as opposed to billions of base pairs in the whole genome), the genetic data extraction service server 125 may extract only the genotypes at or genotyping data of a set of target SNP sites and transmit the extracted data to the computing server 130 as the inheritance dataset of an individual. SNPs, base pair sequences, genotypes, haplotypes, RNA sequences, protein sequences, and phenotypes are examples of biomarkers. In some embodiments, each SNP site may have two readings that are heterozygous.

The computing server 130 performs various analyses of the genetic data, genealogy data, and users' survey responses to generate results regarding the phenotypes and genealogy of users of computing server 130. Depending on the embodiments, the computing server 130 may also be referred to as an online server, a personal genetic service server, a genealogy server, a family tree building server, and/or a social networking system. The computing server 130 receives genetic data from the genetic data extraction service server 125 and stores the genetic data in the data store of the computing server 130. The computing server 130 may analyze the data to generate results regarding the genetics or genealogy of users. The results regarding the genetics or genealogy of users may include the ethnicity compositions of users, paternal and maternal genetic analysis, identification or suggestion of potential family relatives, ancestor information, analyses of DNA data, potential or identified traits such as phenotypes of users (e.g., diseases, appearance traits, other genetic characteristics, and other non-genetic characteristics including social characteristics), etc. The computing server 130 may present or cause the user interface 115 to present the results to the users through a GUI displayed on the client device 110. The results may include graphical elements, textual information, data, charts, and other elements such as family trees.

In some embodiments, the computing server 130 also allows various users to create one or more genealogical profiles of the user. The genealogical profile may include a list of individuals (e.g., ancestors, relatives, friends, and other people of interest) who are added or selected by the user or suggested by the computing server 130 based on the genealogical records and/or genetic records. The user interface 115 controlled by or in communication with the computing server 130 may display the individuals in a list or as a family tree such as in the form of a pedigree chart. In some embodiments, subject to the user's privacy setting and authorization, the computing server 130 may allow information generated from the user's inheritance dataset to be linked to the user profile and to one or more of the family trees. The users may also authorize the computing server 130 to analyze their inheritance dataset and allow their profiles to be discovered by other users.

### Example Computing Server Architecture

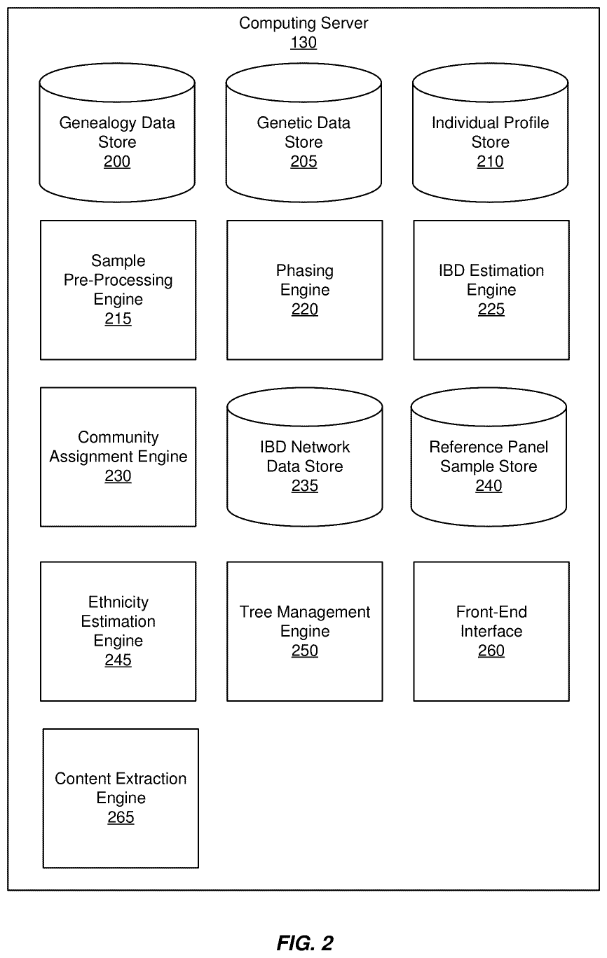

FIG. 2 is a block diagram of the architecture of an example computing server 130, in accordance with some embodiments. In the embodiment shown in FIG. 2, the computing server 130 includes a genealogy data store 200, a genetic data store 205, an individual profile store 210, a sample pre-processing engine 215, a phasing engine 220, an identity by descent (IBD) estimation engine 225, a community assignment engine 230, an IBD network data store 235, a reference panel sample store 240, an ethnicity estimation engine 245, a tree management engine 250, a front-end interface 260, and a content extraction engine 265. The functions of the computing server 130 may be distributed among the elements in a different manner than described. In various embodiments, the computing server 130 may include different components and fewer or additional components. Each of the various data stores may be a single storage device, a server controlling multiple storage devices, or a distributed network that is accessible through multiple nodes (e.g., a cloud storage system).

The computing server 130 stores various data of different individuals, including genetic data, genealogy data, and survey response data. The computing server 130 processes the genetic data of users to identify shared identity-by-descent (IBD) segments between individuals. The genealogy data and survey response data may be part of user profile data. The amount and type of user profile data stored for each user may vary based on the information of a user, which is provided by the user as she creates an account and profile at a system operated by the computing server 130 and continues to build her profile, family tree, and social network at the system and to link her profile with her genetic data. Users may provide data via the user interface 115 of a client device 110. Initially and as a user continues to build her genealogical profile, the user may be prompted to answer questions related to the basic information of the user (e.g., name, date of birth, birthplace, etc.) and later on more advanced questions that may be useful for obtaining additional genealogy data. The computing server 130 may also include survey questions regarding various traits of the users such as the users' phenotypes, characteristics, preferences, habits, lifestyle, environment, etc.

Genealogy data may be stored in the genealogy data store 200 and may include various types of data that are related to tracing family relatives of users. Examples of genealogy data include names (first, last, middle, suffixes), gender, birth locations, date of birth, date of death, marriage information, spouse's information kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual's other relatives including siblings, cousins, and offspring in some cases. Genealogy data may also include connections and relationships among users of the computing server 130. The information related to the connections between a user and her relatives that may be associated with a family tree may also be referred to as pedigree data or family tree data.

In addition to user-input data, genealogy data may also take other forms that are obtained from various sources such as public records and third-party data collectors. For example, genealogical records from public sources include birth records, marriage records, death records, census records, court records, probate records, adoption records, obituary records, etc. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, a motor vehicle database, and the like.

Furthermore, the genealogy data store 200 may also include relationship information inferred from the genetic data stored in the genetic data store 205 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 130 maintains inheritance datasets of individuals in the genetic data store 205. An inheritance dataset of an individual may be a digital dataset of nucleotide data (e.g., SNP data) and corresponding metadata. For example, an inheritance dataset may be genetic data extracted by the genetic data extraction service server 125. An inheritance dataset may contain data on the whole or portions of an individual's genome. The genetic data store 205 may store a pointer to a location associated with the genealogy data store 200 associated with the individual. An inheritance dataset may take different forms. In some embodiments, an inheritance dataset may take the form of a base pair sequence of the sequencing result of an individual. A base pair sequence dataset may include the whole genome of the individual (e.g., obtained from a whole-genome sequencing) or some parts of the genome (e.g., genetic loci of interest). A microarray data may take the form of SNP data at target positions in the genome.

In another embodiment, an inheritance dataset may take the form of sequences of genetic markers. Examples of genetic markers may include target SNP sites (e.g., allele sites) filtered from the DNA identification results. A SNP site that is a single base pair long may also be referred to as a SNP locus. A SNP site may be associated with a unique identifier. The inheritance dataset may be in the form of diploid data that includes a sequence of genotypes, such as genotypes at or genotyping data of the target SNP site, or the whole base pair sequence that includes genotypes at or genotyping data of known SNP sites and other base pair sites that are not commonly associated with known SNPs. The diploid dataset may be referred to as a genotype dataset or a genotype sequence. Genotype may have a different meaning in various contexts. In one context, an individual's genotype may refer to a collection of diploid alleles of an individual. In other contexts, a genotype may be a pair of alleles present on two chromosomes for an individual at a given genetic marker such as a SNP site.

Genotype data for a SNP site may include a pair of alleles. The pair of alleles may be homozygous (e.g., A-A or G-G) or heterozygous (e.g., A-T, C-T). Instead of storing the actual nucleotides, the genetic data store 205 may store genetic data that are converted to bits. For a given SNP site, oftentimes only two nucleotide alleles (instead of all 4) are observed. As such, a 2-bit number may represent a SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at a SNP site. For example, a sequence of haplotypes may refer to a sequence of alleles of an individual that are inherited from a parent.

The individual profile store 210 stores profiles and related metadata associated with various individuals appeared in the computing server 130. A computing server 130 may use unique individual identifiers to identify various users and other non-users that might appear in other data sources such as ancestors or historical persons who appear in any family tree or genealogy database. A unique individual identifier may be a hash of certain identification information of an individual, such as a user's account name, user's name, date of birth, location of birth, or any suitable combination of the information. The profile data related to an individual may be stored as metadata associated with an individual's profile. For example, the unique individual identifier and the metadata may be stored as a key-value pair using the unique individual identifier as a key.

An individual's profile data may include various kinds of information related to the individual. The metadata about the individual may include one or more pointers associating inheritance datasets such as genotype and phased haplotype data of the individual that are saved in the genetic data store 205. The metadata about the individual may also be individual information related to family trees and pedigree datasets that include the individual. The profile data may further include declarative information about the user that was authorized by the user to be shared and may also include information inferred by the computing server 130. Other examples of information stored in a user profile may include biographic, demographic, and other types of descriptive information such as work experience, educational history, gender, hobbies, preferences, location and the like. In some embodiments, the user profile data may also include one or more photos of the users and photos of relatives (e.g., ancestors) of the users that are uploaded by the users. A user may authorize the computing server 130 to analyze one or more photos to extract information, such as the user's or relative's appearance traits (e.g., blue eyes, curved hair, etc.), from the photos. The appearance traits and other information extracted from the photos may also be saved in the profile store. In some cases, the computing server may allow users to upload many different photos of the users, their relatives, and even friends. User profile data may also be obtained from other suitable sources, including historical records (e.g., records related to an ancestor), medical records, military records, photographs, other records indicating one or more traits, and other suitable recorded data.

For example, the computing server 130 may present various survey questions to its users from time to time. The responses to the survey questions may be stored at individual profile store 210. The survey questions may be related to various aspects of the users and the users' families. Some survey questions may be related to users' phenotypes, while other questions may be related to the environmental factors of the users.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, family history of causes of death, etc. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer's disease, diabetes, cancer, and obesity. The computing server 130 may obtain data on a user's disease-related phenotypes from survey questions about the health history of the user and her family and also from health records uploaded by the user.

Survey questions also may be related to other types of phenotypes such as appearance traits of the users. A survey regarding appearance traits and characteristics may include questions related to eye color, iris pattern, freckles, chin types, finger length, dimple chin, earlobe types, hair color, hair curl, skin pigmentation, susceptibility to skin burn, bitter taste, male baldness, baldness pattern, presence of unibrow, presence of wisdom teeth, height, and weight. A survey regarding other traits also may include questions related to users' taste and smell such as the ability to taste bitterness, asparagus smell, cilantro aversion, etc. A survey regarding traits may further include questions related to users' body conditions such as lactose tolerance, caffeine consumption, malaria resistance, norovirus resistance, muscle performance, alcohol flush, etc. Other survey questions regarding a person's physiological or psychological traits may include vitamin traits and sensory traits such as the ability to sense an asparagus metabolite. Traits may also be collected from historical records, electronic health records and electronic medical records.

The computing server 130 also may present various survey questions related to the environmental factors of users. In this context, an environmental factor may be a factor that is not directly connected to the genetics of the users. Environmental factors may include users'preferences, habits, and lifestyles. For example, a survey regarding users' preferences may include questions related to things and activities that users like or dislike, such as types of music a user enjoys, dancing preference, party-going preference, certain sports that a user plays, video game preferences, etc. Other questions may be related to the users' diet preferences such as like or dislike a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g., stretching, flexibility, heart rate recovery), family type (adopted family or not, has siblings or not, lived with extended family during childhood), property and item ownership (has home or rents, has a smartphone or doesn't, has a car or doesn't).

Surveys also may be related to other environmental factors such as geographical, social-economic, or cultural factors. Geographical questions may include questions related to the birth location, family migration history, town, or city of users' current or past residence. Social-economic questions may be related to users' education level, income, occupations, self-identified demographic groups, etc. Questions related to culture may concern users' native language, language spoken at home, customs, dietary practices, etc. Other questions related to users' cultural and behavioral questions are also possible.

For any survey questions asked, the computing server 130 may also ask an individual the same or similar questions regarding the traits and environmental factors of the ancestors, family members, other relatives or friends of the individual. For example, a user may be asked about the native language of the user and the native languages of the user's parents and grandparents. A user may also be asked about the health history of his or her family members.

In addition to storing the survey data in the individual profile store 210, the computing server 130 may store some responses that correspond to data related to genealogical and genetics respectively to genealogy data store 200 and genetic data store 205.

The user profile data, photos of users, survey response data, the genetic data, and the genealogy data may be subject to the privacy and authorization setting of the users to specify any data related to the users that can be accessed, stored, obtained, or otherwise used. For example, when presented with a survey question, a user may select to answer or skip the question. The computing server 130 may present users from time to time information regarding users' selection of the extent of information and data shared. The computing server 130 also may maintain and enforce one or more privacy settings for users in connection with the access of the user profile data, photos, genetic data, and other sensitive data. For example, the user may pre-authorize the access to the data and may change the setting as wished. The privacy settings also may allow a user to specify (e.g., by opting out, by not opting in) whether the computing server 130 may receive, collect, log, or store particular data associated with the user for any purpose. A user may restrict her data at various levels. For example, on one level, the data may not be accessed by the computing server 130 for purposes other than displaying the data in the user's own profile. On another level, the user may authorize anonymization of her data and participate in studies and research conducted by the computing server 130 such as a large-scale genetic study. On yet another level, the user may turn some portions of her genealogy data public to allow the user to be discovered by other users (e.g., potential relatives) and be connected to one or more family trees. Access or sharing of any information or data in the computing server 130 may also be subject to one or more similar privacy policies. A user's data and content objects in the computing server 130 may also be associated with different levels of restriction. The computing server 130 may also provide various notification features to inform and remind users of their privacy and access settings. For example, when privacy settings for a data entry allow a particular user or other entities to access the data, the data may be described as being “visible,” “public,” or other suitable labels, contrary to a “private” label.

In some cases, the computing server 130 may have heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 130 may provide heightened privacy as a default setting for certain types of data, such as genetic data or any data that the user marks as sensitive. The user may opt in to sharing those data or change the default privacy settings. In other cases, the heightened privacy settings may apply across the board for all data of certain groups of users. For example, if computing server 130 determines that the user is a minor or has recognized that a picture of a minor is uploaded, the computing server 130 may designate all profile data associated with the minor as sensitive. In those cases, the computing server 130 may have one or more extra steps in seeking and confirming any sharing or use of the sensitive data.

In some embodiments, the individual profile store 210 may be a large-scale data store. In some embodiments, the individual profile store 210 may include at least 10,000 data records in the form of user profiles and each user profile may be associated with one or more inheritance datasets and one or more genealogical data entries. In some embodiments, the individual profile store 210 may include at least 50,000 data records in the form of user profiles and each user profile may be associated with one or more inheritance datasets and one or more genealogical data entries. In some embodiments, the individual profile store 210 may include at least 100,000 data records in the form of user profiles and each user profile may be associated with one or more inheritance datasets and one or more genealogical data entries. In some embodiments, the individual profile store 210 may include at least 500,000 data records in the form of user profiles and each user profile may be associated with one or more inheritance datasets and one or more genealogical data entries. In some embodiments, the individual profile store 210 may include at least 1,000,000 data records in the form of user profiles and each user profile may be associated with one or more inheritance datasets and one or more genealogical data entries. In some embodiments, the individual profile store 210 may include at least 2,000,000 data records in the form of user profiles and each user profile may be associated with one or more inheritance datasets and one or more genealogical data entries. In some embodiments, the individual profile store 210 may include at least 5,000,000 data records in the form of user profiles and each user profile may be associated with one or more inheritance datasets and one or more genealogical data entries. In some embodiments, the individual profile store 210 may include at least 10,000,000 data records in the form of user profiles and each user profile may be associated with one or more inheritance datasets and one or more genealogical data entries.

The sample pre-processing engine 215 receives and pre-processes data received from various sources to change the data into a format used by the computing server 130. For genealogy data, the sample pre-processing engine 215 may receive data from an individual via the user interface 115 of the client device 110. To collect the user data (e.g., genealogical and survey data), the computing server 130 may cause an interactive user interface on the client device 110 to display interface elements in which users can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, death certificates, etc.

The sample pre-processing engine 215 may also receive raw data from the genetic data extraction service server 125. The genetic data extraction service server 125 may perform laboratory analysis of biological samples of users and generate sequencing results in the form of digital data. The sample pre-processing engine 215 may receive the raw inheritance datasets from the genetic data extraction service server 125. Most of the mutations that are passed down to descendants are related to single-nucleotide polymorphism (SNP). SNP is a substitution of a single nucleotide that occurs at a specific position in the genome. The sample pre-processing engine 215 may convert the raw base pair sequence into a sequence of genotypes of target SNP sites. Alternatively, the pre-processing of this conversion may be performed by the genetic data extraction service server 125. The sample pre-processing engine 215 identifies autosomal SNPs in an individual's inheritance dataset. In some embodiments, the SNPs may be autosomal SNPs. In some embodiments, 700,000 SNPs may be identified in an individual's data and may be stored in genetic data store 205. Alternatively, in some embodiments, an inheritance dataset may include at least 10,000 SNP sites. In another embodiment, an inheritance dataset may include at least 100,000 SNP sites. In yet another embodiment, an inheritance dataset may include at least 300,000 SNP sites. In yet another embodiment, an inheritance dataset may include at least 1,000,000 SNP sites. The sample pre-processing engine 215 may also convert the nucleotides into bits. The identified SNPs, in bits or in other suitable formats, may be provided to the phasing engine 220 which phases the individual's diploid genotypes to generate a pair of haplotypes for each user.

The phasing engine 220 phases a diploid inheritance dataset into a pair of haploid inheritance datasets and may perform imputation of SNP values at certain sites whose alleles are missing. An individual's haplotype may refer to a collection of alleles (e.g., a sequence of alleles) that are inherited from a parent.

Phasing may include a process of determining the assignment of alleles (particularly heterozygous alleles) to chromosomes. Owing to conditions and other constraints in sequencing or microarray, a DNA identification result often includes data regarding a pair of alleles at a given SNP locus of a pair of chromosomes but may not be able to distinguish which allele belongs to which specific chromosome. The phasing engine 220 uses a genotype phasing algorithm to assign one allele to a first chromosome and another allele to another chromosome. The genotype phasing algorithm may be developed based on an assumption of linkage disequilibrium (LD), which states that haplotype in the form of a sequence of alleles tends to cluster together. The phasing engine 220 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio is used as a training sample because the correct phasing of the child is almost certain by comparing the child's genotypes to the parent's inheritance datasets. The haplotype-cluster model may be generated iteratively along with the phasing process with a large number of unphased genotype datasets. The haplotype-cluster model may also be used to impute one or more missing data.

By way of example, the phasing engine 220 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 220 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Pat. No. 10,679,729, entitled “Haplotype Phasing Models,” granted on Jun. 9, 2020, describes example embodiments of haplotype phasing.

A phasing algorithm may also generate phasing result that has a long genomic distance accuracy and cross-chromosome accuracy in terms of haplotype separation. For example, in some embodiments, an IBD-phasing algorithm may be used, which is described in further detail in U.S. Patent Application Publication No. US 2021/0034647, entitled “Clustering of Matched Segments to Determine Linkage of Dataset in a Database,” published on Feb. 4, 2021. For example, the computing server 130 may receive a target individual genotype dataset and a plurality of additional individual genotype datasets that include haplotypes of additional individuals. For example, the additional individuals may be reference panels or individuals who are linked (e.g., in a family tree) to the target individual. The computing server 130 may generate a plurality of sub-cluster pairs of first parental groups and second parental groups. Each sub-cluster pair may be in a window. The window may correspond to a genomic segment and has a similar concept of window used in the ethnicity estimation engine 245 and the rest of the disclosure related to HMMs, but how windows are precisely divided and defined may be the same or different in the phasing engine 220 and in an HMM. Each sub-cluster pair may correspond to a genetic locus. In some embodiments, each sub-cluster pair may have a first parental group that includes a first set of matched haplotype segments selected from the plurality of additional individual datasets and a second parental group that includes a second set of matched haplotype segments selected from the plurality of additional individual datasets. The computing server 130 may generate a super-cluster of a parental side by linking the first parental groups and the second parental groups across a plurality of genetic loci (across a plurality of sub-cluster pairs). Generating the super-cluster of the parental side may include generating a candidate parental side assignment of parental groups across a set of sub-cluster pairs that represent a set of genetic loci in the plurality of genetic loci. The computing server 130 may determine the number of common additional individual genotype datasets that are classified in the candidate parental side assignment. The computing server 130 may determine the candidate parental side assignment to be part of the super-cluster based on the number of common additional individual genotype datasets. Any suitable algorithms may be used to generate the super-cluster, such as a heuristic scoring approach, a bipartite graph approach, or another suitable approach. The computing server 130 may generate a haplotype phasing of the target individual from the super-cluster of the parental side.

The IBD estimation engine 225 estimates the amount of shared genetic segments between a pair of individuals based on phased genotype data (e.g., haplotype datasets) that are stored in the genetic data store 205. IBD segments may be segments identified in a pair of individuals that are putatively determined to be inherited from a common ancestor. The IBD estimation engine 225 retrieves a pair of haplotype datasets for each individual. The IBD estimation engine 225 may divide each haplotype dataset sequence into a plurality of windows. Each window may include a fixed number of SNP sites (e.g., about 100 SNP sites). The IBD estimation engine 225 identifies one or more seed windows in which the alleles at all SNP sites in at least one of the phased haplotypes between two individuals are identical. The IBD estimation engine 225 may expand the match from the seed windows to nearby windows until the matched windows reach the end of a chromosome or until a homozygous mismatch is found, which indicates the mismatch is not attributable to potential errors in phasing or imputation. The IBD estimation engine 225 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 130 may save data regarding individual pairs who share a length of IBD segments exceeding a predetermined threshold (e.g., 6 cM), in a suitable data store such as in the genealogy data store 200. U.S. Pat. No. 10,114,922, entitled “Identifying Ancestral Relationships Using a Continuous stream of Input,” granted on Oct. 30, 2018, and U.S. Pat. No. 10,720,229, entitled “Reducing Error in Predicted Genetic Relationships,” granted on Jul. 21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, while close family members often share upwards of 71 cM of IBD (e.g., third cousins), more distantly related individuals may share less than 12 cM of IBD. The extent of relatedness in terms of IBD segments between two individuals may be referred to as IBD affinity. For example, the IBD affinity may be measured in terms of the length of IBD segments shared between two individuals.

Community assignment engine 230 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish who immigrated to America in 1800, Irish who immigrated to America in 1900, etc. The community classification may also depend on whether a population is admixed or unadmixed. For an admixed population, the classification may further be divided based on different ethnic origins in a geographical region.

Community assignment engine 230 may assign individuals to one or more genetic communities based on their inheritance datasets using machine learning models trained by unsupervised learning or supervised learning. In an unsupervised approach, the community assignment engine 230 may generate data representing a partially connected undirected graph. In this approach, the community assignment engine 230 represents individuals as nodes. Some nodes are connected by edges whose weights are based on IBD affinity between two individuals represented by the nodes. For example, if the total length of two individuals' shared IBD segments does not exceed a predetermined threshold, the nodes are not connected. The edges connecting two nodes are associated with weights that are measured based on the IBD affinities. The undirected graph may be referred to as an IBD network. The community assignment engine 230 uses clustering techniques such as modularity measurement (e.g., the Louvain method) to classify nodes into different clusters in the IBD network. Each cluster may represent a community. The community assignment engine 230 may also determine sub-clusters, which represent sub-communities. The computing server 130 saves the data representing the IBD network and clusters in the IBD network data store 235. U.S. Pat. No. 10,223,498, entitled “Discovering Population Structure from Patterns of Identity-By-Descent,” granted on Mar. 5, 2019, describes example embodiments of community detection and assignment.

The community assignment engine 230 may also assign communities using supervised techniques. For example, inheritance datasets of known genetic communities (e.g., individuals with confirmed ethnic origins) may be used as training sets that have labels of the genetic communities. Supervised machine learning classifiers, such as logistic regressions, support vector machines, random forest classifiers, and neural networks may be trained using the training set with labels. A trained classifier may distinguish binary or multiple classes. For example, a binary classifier may be trained for each community of interest to determine whether a target individual's inheritance dataset belongs or does not belong to the community of interest. A multi-class classifier such as a neural network may also be trained to determine whether the target individual's inheritance dataset most likely belongs to one of several possible genetic communities.

Reference panel sample store 240 stores reference panel samples for different genetic communities. A reference panel sample is the genetic data of an individual whose genetic data is the most representative of a genetic community. The genetic data of individuals with the typical alleles of a genetic community may serve as reference panel samples. For example, some alleles of genes may be over-represented (e.g., being highly common) in a genetic community. Some inheritance datasets include alleles that are commonly present among members of the community. Reference panel samples may be used to train various machine learning models in classifying whether a target inheritance dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., containing fewer than 1000 nodes). For example, the community assignment engine 230 may construct a full IBD network that includes a set of individuals represented by nodes and generate communities using clustering techniques. The community assignment engine 230 may randomly sample a subset of nodes to generate a sampled IBD network. The community assignment engine 230 may recursively apply clustering techniques to generate communities in the sampled IBD network. The sampling and clustering may be repeated for different randomly generated IBD networks for various runs. Nodes that are consistently assigned to the same genetic community when sampled in various runs may be classified as a reference panel sample. The community assignment engine 230 may measure the consistency in terms of a predetermined threshold. For example, if a node is classified to the same community 95% (or another suitable threshold) of the times the node is sampled, the inheritance dataset corresponding to the individual represented by the node may be regarded as a reference panel sample. Additionally, or alternatively, the community assignment engine 230 may select N most consistently assigned nodes as a reference panel for the community.

Other ways to generate reference panel samples are also possible. For example, the computing server 130 may collect a set of samples and gradually filter and refine the samples until high-quality reference panel samples are selected. For example, a candidate reference panel sample may be selected from an individual whose recent ancestors were born at a certain birthplace. The computing server 130 may also draw sequence data from the Human Genome Diversity Project (HGDP). Various candidates may be manually screened based on their family trees, relatives' birth location, and other quality controls. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 245 estimates the ethnicity composition of an inheritance dataset of a target individual. The inheritance datasets used by the ethnicity estimation engine 245 may be genotype datasets or haplotype datasets. For example, the ethnicity estimation engine 245 estimates the ancestral origins (e.g., ethnicity) based on the individual's genotypes or haplotypes at the SNP sites. To take a simple example of three ancestral populations corresponding to African, European and Native American, an admixed user may have nonzero estimated ethnicity proportions for all three ancestral populations, with an estimate such as [0.05, 0.65, 0.30], indicating that the user's genome is 5% attributable to African ancestry, 65% attributable to European ancestry and 30% attributable to Native American ancestry. The ethnicity estimation engine 245 generates the ethnic composition estimate and stores the estimated ethnicities in a data store of computing server 130 with a pointer in association with a particular user.

In some embodiments, the ethnicity estimation engine 245 divides a target inheritance dataset into a plurality of windows (e.g., about 1000 windows). Each window includes a small number of SNPs (e.g., 300 SNPs). The ethnicity estimation engine 245 may use a directed acyclic graph model to determine the ethnic composition of the target inheritance dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 245 determines the emission probabilities by comparing SNPs in the window corresponding to the target inheritance dataset to corresponding SNPs in the windows in various reference panel samples of different genetic communities stored in the reference panel sample store 240. The transition probability between two nodes represents the likelihood of transition from one node to another across two levels. The ethnicity estimation engine 245 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 245 determines the ethnic composition of the target inheritance dataset by determining the label compositions of the nodes that are included in the determined path. U.S. Pat. No. 10,558,930, entitled “Local Genetic Ethnicity Determination System,” granted on Feb. 11, 2020, and U.S. Pat. No. 10,692,587, granted on Jun. 23, 2020, entitled “Global Ancestry Determination System” describe different example embodiments of ethnicity estimation.

The tree management engine 250 performs computations and other processes related to users' management of their data trees such as family trees. The tree management engine 250 may allow a user to build a data tree from scratch or to link the user to existing data trees. In some embodiments, the tree management engine 250 may suggest a connection between a target individual and a family tree that exists in the family tree database by identifying potential family trees for the target individual and identifying one or more most probable positions in a potential family tree. A user (target individual) may wish to identify family trees to which he or she may potentially belong. Linking a user to a family tree or building a family may be performed automatically, manually, or using techniques with a combination of both. In an embodiment of an automatic tree matching, the tree management engine 250 may receive an inheritance dataset from the target individual as input and search related individuals that are IBD-related to the target individual. The tree management engine 250 may identify common ancestors. Each common ancestor may be common to the target individual and one of the related individuals. The tree management engine 250 may in turn output potential family trees to which the target individual may belong by retrieving family trees that include a common ancestor and an individual who is IBD-related to the target individual. The tree management engine 250 may further identify one or more probable positions in one of the potential family trees based on information associated with matched genetic data between the target individual and those in the potential family trees through one or more machine learning models or other heuristic algorithms. For example, the tree management engine 250 may try putting the target individual in various possible locations in the family tree and determine the highest probability position(s) based on the inheritance dataset of the target individual and inheritance datasets available for others in the family tree and based on genealogy data available to the tree management engine 250. The tree management engine 250 may provide one or more family trees from which the target individual may select. For a suggested family tree, the tree management engine 250 may also provide information on how the target individual is related to other individuals in the tree. In a manual tree building, a user may browse through public family trees and public individual entries in the genealogy data store 200 and individual profile store 210 to look for potential relatives that can be added to the user's family tree. The tree management engine 250 may automatically search, rank, and suggest individuals for the user conduct manual reviews as the user makes progress in the front-end interface 260 in building the family tree.

As used herein, “pedigree” and “family tree” may be interchangeable and may refer to a family tree chart or pedigree chart that shows, diagrammatically, family information, such as family history information, including parentage, offspring, spouses, siblings, or otherwise for any suitable number of generations and/or people, and/or data pertaining to persons represented in the chart. U.S. Pat. No. 11,429,615, entitled “Linking Individual Datasets to a Database,” granted on Aug. 30, 2022, describes example embodiments of how an individual may be linked to existing family trees.

The front-end interface 260 may render a front-end platform that displays various results determined by the computing server 130. The platform may take the form of a genealogy research and family tree building platform and/or a personal DNA data analysis platform. The platform may also serve as a social networking system that allows users and connect and build family trees and research family relations together. The results and data may include the IBD affinity between a user and another individual, the community assignment of the user, the ethnicity estimation of the user, phenotype prediction and evaluation, genealogy data search, family tree and pedigree, relative profile and other information. The front-end interface 260 may allow users to manage their profile and data trees (e.g., family trees). The users may view various public family trees stored in the computing server 130 and search for individuals and their genealogy data via the front-end interface 260. The computing server 130 may suggest or allow the user to manually review and select potentially related individuals (e.g., relatives, ancestors, close family members) to add to the user's data tree. The front-end interface 260 may be a graphical user interface (GUI) that displays various information and graphical elements.

The front-end interface 260 may take different forms. In one case, the front-end interface 260 may be a software application that can be displayed on an electronic device such as a computer or a smartphone. The software application may be developed by the entity controlling the computing server 130 and be downloaded and installed on the client device 110. In another case, the front-end interface 260 may take the form of a webpage interface of the computing server 130 that allows users to access their family tree and genetic analysis results through web browsers. In yet another case, the front-end interface 260 may provide an application program interface (API). In some embodiments, the front-end interface 260 may be rendered as part of the content in an extended reality device, such as a head-mounted display or a phone camera that is integrated with augmented reality features.

The front-end interface 260 may provide various front-end visualization features. In some embodiments, a family tree viewer may render family tree built by users and/or managed by the tree management engine 250. The family tree may be displayed in a nested nodes and edges connected based on family relationships or genetic matches determined by various genetic data analysis engines discussed in FIG. 2. The family trees may include attached records that are part of records in the genealogy data store 200, including records that are uploaded by users and gallery images. The user may assign a focal person to a family tree and the family tree is displayed with the focus (such as positioning the focal person at the center or relative prominent position of the tree) around the focal person. A user may change the focal person and the family tree may shift accordingly based on the relationships and relative positions of members in the family tree. Each person in the family tree may be associated with historical photos from gallery images, historical genealogy records such as life event records, one or more stories and live events associated with the person, and metadata such as family relationships and other family trees associated with the person.

In some embodiments, visualization features provided by the front-end interface 260 may include a map feature. A map may be a geographical map that may take the form of a digital map, a historical physical map, and/or a historical map overlaid on a digital map. A user may select a geographical location and the front-end interface 260 displays relevant genealogical or genetic records associated with the location, such as an ancestor's lifetime events, birth locations of DNA matches, mitigation patterns of ancestors across different locations over time and associated genealogical records, residence maps that provide specific locations of historical persons' events, and historical maps overlaying on a digital map to contextualize ancestors' records and events. The map feature may also provide interactive features to allow users to view historical documents, photographs, and stores associated with the geographical locations. The map feature may also allow users to adjust timeframes, displaying changes in locations and migrations over different periods.

In some embodiments, visualization features provided by the front-end interface 260 may include a story feature that provides multimedia narratives about a person, such as the person's live events and family history. The story feature allows a user to compile various graphical and genealogical elements such as photos, documents, historical records, and personal anecdotes into a timeline to summarize a narrative. The story may be arranged in an appropriate spatial manner such as a linear arrangement that arranges various graphical elements based on the creator's selection.

In this disclosure, a genetic data may be an example of inheritance data. An individual is an example of a named entity. A genetic sequence is an example of data string or bit string. A genetic segment is an example of data string segment. A matched genetic segment is an example of matched data string. For example, an IBD segment is an example of a matched data string segment. An ethnicity is an example or a data origin or a data classification. A phenotype, or a phenotypic trait, is an example of a data manifestation, and both “phenotype” and “phenotypic trait” are used interchangeably herein. A reproductive event is an example of a data inheritance event.

The content extraction engine 265 may provide a multi-stage process for extracting entities and relationships in a genealogical record to construct a family tree. For example, the content extraction engine 265 may use and train machine learning models for extracting entities and relationships from images of genealogical records to construct family trees.

### Extracting Entities and Relationships From a Family History Book

A transformer pipeline is used to extract entities and relationships in a genealogical record to automatically construct a family tree. A token slide window is used to scan text tokens from the genealogical record without regard to actual segmentations. An entity is extracted using a first fine-tuned bi-directional encoder. Entity relationships are determined using a second fine-tuned bi-directional encoder. For cross-page (different pages of the record, e.g. book) relationships, segmentations and heuristics are used to determine the relationships of the entities. The extracted relationships and entities are normalized and post-processed. A family tree is automatically generated based on the extracted relationships.

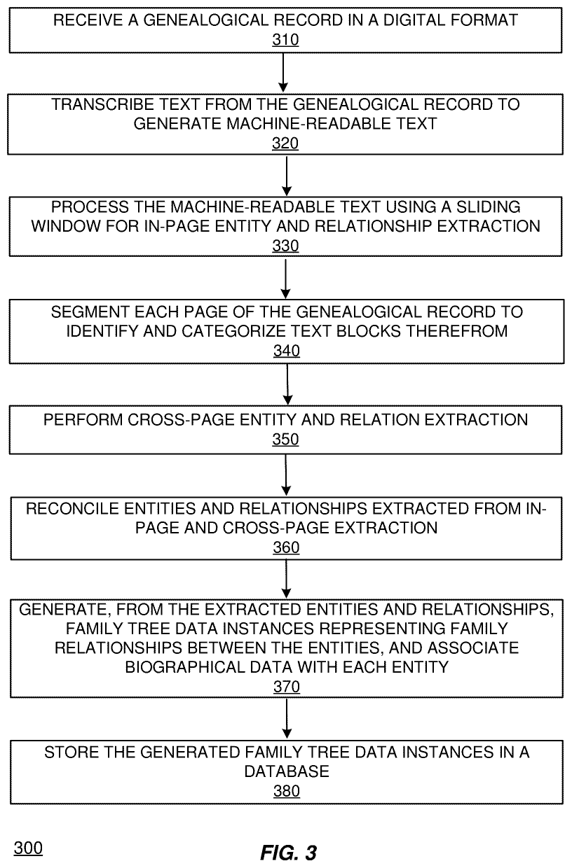

FIG. 3 is a flowchart depicting an example process 300 for extracting entities and relationships in genealogical records. The process 300 may be performed by one or more engines of the computing server 130 illustrated in FIG. 2, such as the content extraction engine 265. The process 300 may be embodied as a software algorithm that may be stored as computer instructions that are executable by one or more processors. The instructions, when executed by the processors, cause the processors to perform various steps in the process 300. In various embodiments, the process 300 may include additional, fewer, or different steps. While various steps in the process 300 may be discussed with the use of computing server 130, each step may be performed by a different computing device.

The computing server 130 can receive a genealogical record in a digital format (step 310). The genealogical records can be stored in databases or archives maintained by genealogical organizations, libraries, or companies. The genealogical records may be scanned and digitized if they were originally in physical form. For example, the digital format can be an image file (e.g., JPEG, TIFF) or a PDF. The digitized genealogical records can be stored in cloud storage systems or on-premises servers. When the computing server 130 needs to process a genealogical record, it can access and retrieve it from the storage locations via secure network connections or APIs.

Genealogical records can come in various types. Genealogical records may include, but not be limited to, family history books, census records, birth/death/marriage certificates, military records, immigration documents, newspaper articles, personal diaries or letters, etc. The genealogical records can provide valuable information for constructing family trees and understanding historical context. For example, a family history book can be a source of information that combines multiple family generations and data in a single document. The computing server 130 can receive and process various types of genealogical records in digital formats.

The computing server 130 can transcribe text from the genealogical record to generate machine-readable text (step 320). In some embodiments, the computing server 130 may transcribe text from the genealogical record using OCR technology. This process can convert image-based text in the digitized genealogical record into machine-readable text. This process can handle various forms of text, including printed text and handwritten text. The transcribed text may be saved in a format such as a structured format (e.g., JavaScript object notation (JSON) or XML). The format of the transcribed text can allow for easy parsing and processing of the machine-readable text in subsequent steps. The format of the machine-readable text can preserve not only the text content but also structural information about the genealogical record, such as the location of text blocks on a page thereof. The machine-readable text may be stored in text files or databases linked to the computer server 130 for retrieval and processing.

The computing server 130 can process the machine-readable text using a sliding window for in-page entity and relationship extraction (step 330). In one approach, the computing server 130 can process the machine-readable text using a sliding window. The sliding window may be a technique used to process text by selecting a fixed-length portion of consecutive tokens, analyzing it, and then moving the window forward by a predetermined number of tokens to cover the next portion of text, repeating this process until the entire document has been processed.

The computing server 130 can use the sliding window to process text by considering a fixed number of consecutive tokens (words or characters) at a time, then moving or sliding the window over another portion of the text to cover the rest of the machine-readable text of the genealogical record. The data in the sliding window can be held in memory during processing for efficient analysis of the current text portion. The size of the sliding window can be measured in tokens, with each token usually representing a word or a subword unit. In some embodiments, the sliding window size can be between 256 to 512 tokens. For example, the sliding window size can be 500 tokens, which can equate to approximately 500 words. In some embodiments, the sliding window size can vary depending on system configuration.

As the computing server 130 processes machine-readable text, the sliding window can move through the genealogical record with a predetermined overlap to provide continuity in processing and to discover relationships that might span the boundaries of individual sliding windows. In some embodiments, the size of the predetermined overlap can be between 5 and 10 tokens. The overlap size may be chosen to balance between providing continuity in processing (capturing relationships that span window boundaries) and maintaining computational efficiency. In some embodiments, the overlap size can allow the system to effectively process text while minimizing redundant computations, such that important information spanning window boundaries is not missed during the analysis of the genealogical record.

The computer server 130 can extract multiple entities from the selected portion of text. An entity can be data of interest within the machine-readable text. An entity may represent a person, a place, a date, or an event. Examples of entities in genealogical records can include names (e.g., John Smith), dates (e.g., Jun. 15, 1850), places (e.g., Boston, Massachusetts), and events (e.g., marriage, birth). The extracted entities may be saved in a structured format such as JSON or XML, which allows for easy processing and linking of information. The format would typically include the entity text, its type (person, place, date, etc.), and possibly its position within the original text.

In one approach, the computing server 130 can use a machine learning model (e.g., a transformer model) to extract the plurality of entities from the selected portion of text. For example, the computing server 130 may input, into the machine learning model, the selected portion of text of the predetermined token length. Responsive to the inputs, the machine learning model can output the entities discovered from the selected portion of text. In some embodiments, the machine learning model can include a transformer-based machine learning model specifically designed for entity extraction tasks. More information about the machine learning mode is provided under the section Machine Learning Model.

The computer server 130 can determine relationships between these extracted entities. Relationships can refer to the connections or associations between the extracted entities. The relationships can include familial and historical connections relevant to genealogical records. In some embodiments, a relationship may be defined as a link between two or more entities that provides context or information about how they are connected. Examples of relationships in genealogical records may include, but not be limited to, family relationships (e.g., parent-child, spouse, sibling), event-person relationships (e.g., birth of, death of, marriage of), person-place relationships (e.g., born in, resided in), person-date relationships (e.g., born on, married on), and event-date relationships (e.g., occurred on, started on). For example, if “John Smith” and “Mary Johnson” are extracted as person entities, and “June 15, 1850” is extracted as a date entity, a relationship may be established that “John Smith” and “Mary Johnson” were married on “June 15, 1850.” These relationships may be used for constructing family trees and understanding the historical context of individuals mentioned in the genealogical records. The computing server can use the relationships to build a network of connections between the extracted entities. This network of connections may be used to generate family tree data instances.

In one approach, the computing server 130 can use a machine learning model (e.g., a transformer model) to determine relationships between the extracted entities from the selected portion of text. For example, the computing server 130 may input, into the machine learning model, the extracted entities. Responsive to the inputs, the machine learning model can output the relationships between the extracted entities. In some embodiments, the machine learning model can include a transformer-based machine learning model specifically designed for determining relationships between entities. More information about the machine learning mode is provided under the section Machine Learning Model.

In some embodiments, in the case of a multi-page genealogical record, the transcription process can generate a continuous stream of machine-readable text that represents the entire genealogical record, regardless of page boundaries. This approach can allow for seamless processing using the sliding window technique. For example, the sliding window can move through the continuous stream of machine-readable text, without having to account for original page breaks in the genealogical record. The window can slide from the beginning of the machine-readable text to the end, crossing what were originally page boundaries without interruption.

The computer server 130 can shift the sliding window by a predetermined overlap to select a next portion of text. Shifting the sliding window can represent moving the focus of the analysis to a new portion of the machine-readable text of the genealogical record by advancing the start and end points of the sliding window by a certain number of tokens. For example, with a 500-token window and 10-token overlap, the first sliding window may cover tokens 1-500, the second sliding window tokens 491-990, and the third sliding window tokens 981-1480. This process of shifting and analyzing sliding windows may continue until all the machine-readable text of the genealogical record has been processed.

The computing server 130 can segment each page of the genealogical record to identify and categorize text blocks therefrom (step 340). The segmentation process can be used for understanding the genealogical record's structure. The text blocks can be distinct sections of text that serve specific purposes, such as paragraphs, lists, headings, or captions. In some embodiments, the computing server 130 can segment each page by using a page segmentation model (e.g., a computer vision model, Detectron2, etc.). The page segmentation model can analyze the layout and structure of each page, identifying different text areas and categorizing them based on their visual characteristics and position on the page. The identified text blocks can be stored in a format like JSON or XML, which may include information about each text block's position, size, and category (e.g., paragraph, list, heading).

The computing server 130 can perform cross-page entity and relation extraction to capture information that spans across page boundaries (step 350). This process can allow the computing server 130 to recognize content that may be continuous across page boundaries. In one approach, the computing server 130 can identify related text portions from two adjacent pages, using the text blocks that were previously identified during the page segmentation step. Adjacent pages can be defined as two consecutive pages in the genealogical record, typically numbered sequentially. It will, however, be appreciated that the disclosure is not limited thereto; rather, as suitable, adjacent pages can be nonconsecutive pages, such as, for example, where a particular narrative section, table, or other structure is noted to continue on a particular, nonconsecutive page. The computing server 130 may be configured to determine adjacency of pages on the basis of such contextual information as suitable. The computing server 130 may identify adjacent pages through the metadata generated during the initial digitization and OCR processes, which includes page numbers and ordering information. In some embodiments, to perform cross-page entity and relationship extraction, the computing server 130 can identify related text portions from two adjacent pages using the text blocks previously identified during the page segmentation step. For example, the computing server 130 may identify and process the bottom portion of one page and the top portion of the following page, as these areas are most likely to contain continuous content.

Based on the identified related text portions, the computing server 130 can extract entities and relationships that span across the two adjacent pages. This process can allow the computing server 130 to capture and process information that may be split between pages. In some embodiments, the computing server 130 may then apply the same entity and relationship extraction machine learning models to these selected text portions, allowing them to recognize and extract entities and relationships that may be split across the page break. This process can provide that important connections and data are not missed due to the physical constraints of the original genealogical record's layout, maintaining the continuity of information across pages.

The computing server 130 can reconcile entities and relationships extracted from in-page and cross-page extraction to create a cohesive and accurate representation of the genealogical information (step 360). Reconciliation can include identifying and merging duplicate entities, resolving conflicts, and establishing connections between entities across different parts of the genealogical record. For example, if “John Smith” is mentioned at the bottom of page 10 as a father and on the top of page 11 as a grandfather, the computing server 130 can recognize these as referring to the same person and combine the information.

In one approach, the computing server 130 can disambiguate the entities mentioned multiple times throughout the machine-readable text. For example, the computing server 130 can disambiguate entities by determining when multiple mentions refer to the same individual, considering context, relationships, and other identifying information. For example, this process may include recognizing that “J. Smith” and “John Smith” refer to the same person based on surrounding context.

Additionally, the computing server 130 can normalize biographical data including date data and location data. Normalization can include standardizing the data into a consistent format. An example may include converting dates to a standard format like YYYY-MM-DD, or standardizing location names to match a geographical location database. This process can provide consistency across the extracted data, facilitating accurate family tree construction and data analysis.

The computing server 130 can generate, from the extracted entities and relationships, family-tree data instances representing family relationships between the entities, and associate biographical data with each entity (step 370). Family-tree data instances can be structured representations of familial connections, typically including parent-child relationships, spousal relationships, and sibling relationships. For example, a family-tree data instance may represent “John Smith” as the father of “Mary Smith” and “James Smith,” and the spouse of “Sarah Johnson.” The process can include organizing the reconciled and normalized data into a hierarchical structure that reflects genealogical relationships.

The computing server 130 can analyze the extracted relationships to determine how individuals are connected, and create data structures that represent these connections. Each entity in the family tree can be associated with its corresponding biographical data, such as birth date, death date, and locations of significant life events. In some embodiments, the computing server 130 can transform the extracted information into a format that can be easily visualized as a traditional family tree.

In some embodiments, the family tree data instances may include structured data formats, using hierarchical or graph-based data structures. Each individual in the family tree may be represented as a node containing biographical data such as name, birth date, death date, and locations. Relationships between individuals may be represented as edges connecting the nodes, typically directional and labeled to indicate the type of relationship (e.g., parent of, child of, spouse of). The data structure can be implemented in various formats such as JSON objects, XML structures, or custom object-oriented classes. Each node may have attributes including a unique identifier, name, gender, birth and death information, marriage details, and other life events. Relationships can be stored as references or pointers to other nodes, or as arrays of child, parent, and spouse IDs. The data structure can allow for representation of multiple generations, with the ability to traverse up to ancestors or down to descendants through the family tree. The data structure can provide for efficient storage, retrieval, and analysis of family relationships and individual biographical data within the context of the larger family tree.

The computing server 130 can store the generated family-tree data instances in a database (step 380). This storage process can include saving the family-tree data instances, including all individual entities, their biographical data, and their relationships, into a persistent storage system. The storage process can include creating appropriate database schemas or document structures, mapping the data from the family-tree data instances to these structures, and executing database operations to insert or update the data. This storage process can provide that the processed genealogical information is persistently stored, easily retrievable for future use, and can be efficiently queried or analyzed for various purposes such as generating visual family trees, conducting genealogical research, or integrating with other genealogical databases.

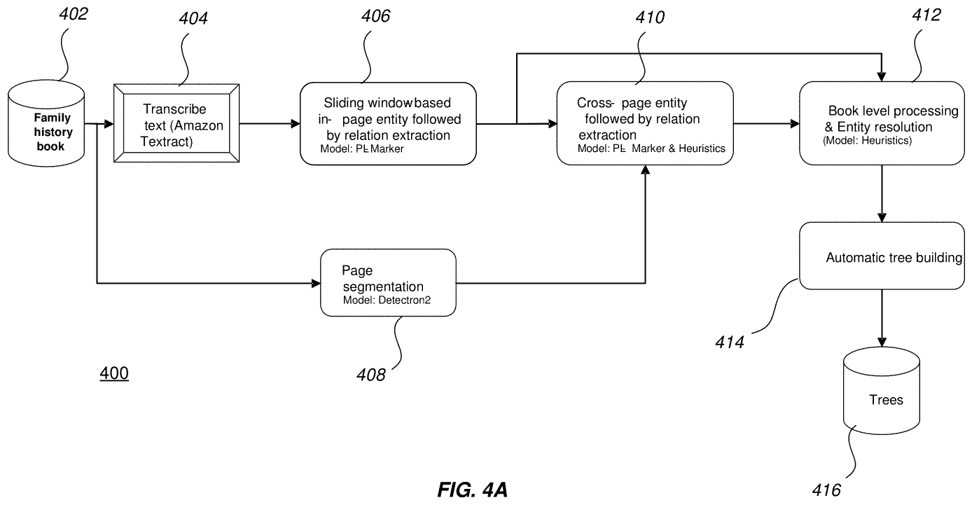

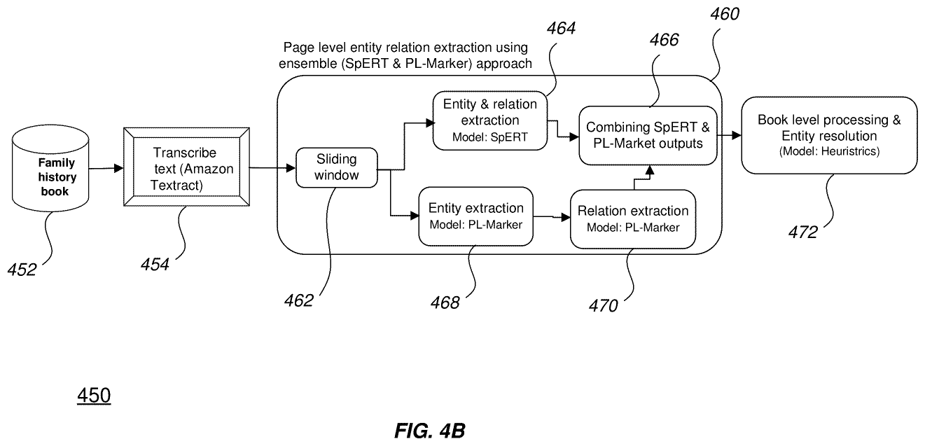

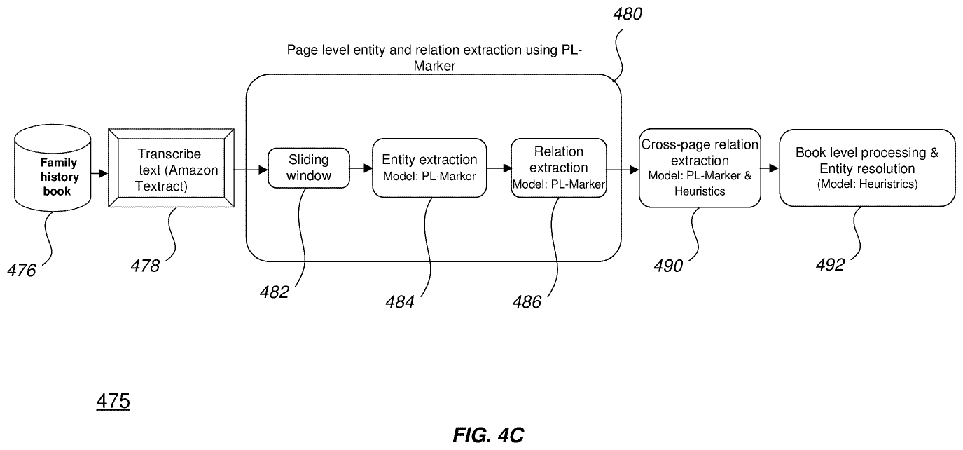

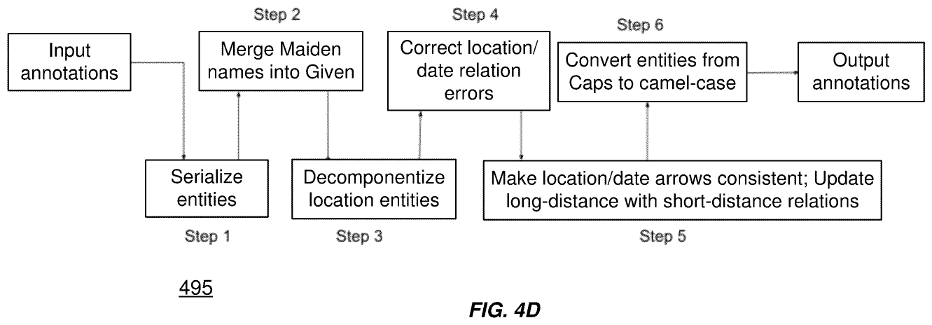

FIG. 4A illustrates a system architecture 400 for extracting entities and relationships from genealogical records, specifically family history books. The process begins at step 402 with a family history book stored in a database. In step 404, the computing server 130 transcribes all text from the family history book using OCR technology. Two processes can be performed in parallel: at 406, the computing server 130 uses a sliding window approach for in-page entity and relation extraction on the transcribed text; while at 408, the computing server 130 performs page segmentation on the family history book using a machine learning model (e.g., a transformer, such as Detectron2). Step 410 combines outputs from steps 406 and 408 to perform cross-page entity and relationship extraction, utilizing using machine learning models and heuristics. In step 412, the computing server 130 performs book-level processing and entity resolution using heuristics, integrating information from steps 406 and 410. Step 414 includes building family trees based on the processed and resolved data from step 412. At step 416, the generated family trees are saved to a database. This architecture represents an approach to processing genealogical records, from raw text extraction to the creation of structured family tree data.

Heuristics can be used in several steps of the system architecture 400. In cross-page entity and relation extraction, heuristics are used alongside the machine learning model (e.g., transformer or transfer-based model, e.g. a Packed Levitation Marker for Entity and Relation Extraction “PL-Marker” model) to determine how to connect information across page boundaries, considering factors like text position, context, and content. In book-level processing and entity resolution, heuristics can be used to disambiguate entities, resolving coreferences, normalizing dates and locations, and assembling name parts. The heuristics are typically based on domain knowledge about genealogical records, common patterns in family history books, and general rules about how information is typically presented in these documents. The heuristics help in making informed decisions when processing and interpreting the extracted data, filling in gaps where machine learning models alone may not be sufficient.

Turning now to FIG. 4B, another system architecture 450 for extracting entities and relationships from genealogical records, specifically family history books, is shown. The system architecture 450 of FIG. 4B includes a pipeline for receiving a record input 452, such as a family history book, and transforming the same into resolved entities and detected relationships 472 from which family trees can be automatedly generated. The system architecture 450 may include a transcription modality 454, such as a commercially available tool such as Amazon Textract, or any other suitable transcription approach or component. The transcription modality 454 may be configured to output, based on the received family history book input 452, text data, including structured text data, from which entities and relationships therebetween may be extracted by a ML model ensemble 460. The ensemble 460 may include the use of a sliding window 462 technique for extracting a predetermined number of tokens for processing in batches, as described above regarding FIG. 4A reference numeral 406.

In the embodiment of FIG. 4B, a parallel approach to entity extraction and relation extraction using a PL-marker or other suitable modality and Span-based Entity and Relation Transformer (“SpERT”) or other suitable modality. In an embodiment, the SpERT pipeline of the ensemble 460 may perform both entity extraction and relation detection in a single step in stage/module 464, while the PL-marker pipeline of the ensemble 460 may perform entity extraction and relation detection separately, in respective stages/modules 468, 470. In a step/module 466, outputs of the SpERT pipeline and the PL-Marker pipelines may be combined. The outputs of the SpERT pipeline and the PL-Marker pipeline may include detected entities and relationships therebetween, which may be formatted in any suitable manner, including with directional edges representing relationship types (e.g., “spouse of”) between nodes representing extracted entities (e.g., “John Smith”).

The step/module 466 may include any suitable approach to combining outputs, including weighing confidence scores associated with particular outputs to select one or the other, resolving similar outputs to a same output (e.g., where one pipeline suggests that “Jane Smith”→spouse of→“Jn Smith” and the other suggests that “J Smith” spouse of→“John Smith”, the step/module 466 may resolve the two outputs to a unified output “Jane Smith” spouse of→“John Smith”. The output from the step/module 466 may be provided to a step/module 472 in which the output is processed and entity-resolved on a book level. In embodiments, the step/module 472 is configured to resolve entities and relationships extracted from different pages of a family history book but which pertain to a same entity. Other heuristics may be applied, such as heuristics for joining extracted entities and relationships into a family tree structure comprising multiple generations of entities. For instance, the outputs “Jane Smith” spouse of→“John Smith” may be concatenated with additional resolved entities, such as “Robert Smith” son of→“Jane Smith”, such that Robert is shown as a descendant of John and Jane Smith in a pedigree structure.

Turning now to FIG. 4C, yet another system architecture 475 for extracting entities and relationships from genealogical records, specifically family history books, is shown. The architecture 475 may be configured to utilize a pipeline for receiving a record input 476, such as a family history book, and transforming the same into resolved entities and detected relationships 492 from which family trees can be automatedly generated. The system architecture 475 may, as described above regarding the embodiment of FIG. 4B, include a transcription modality 478, such as a commercially available tool such as Amazon Textract, or any other suitable transcription approach or component. A page-level ML module 480 may comprise a plurality of steps/module 482, 484, 486, for, respectively, utilizing a sliding window as described above regarding previous embodiments, performing entity extraction, and performing relation extraction or detection. The sliding window step/module 482, as described previously, may advantageously utilize a sliding window for focusing on a predetermined window or number of tokens, thereby facilitating in-memory processing. An output of the sliding window step/module 482 may include a plurality of tokens corresponding to particular applications of the sliding window. The entity extraction step/module 484 may utilize a PL-Marker model or other suitable modality for entity extraction, with outputs of the entity extraction step/module 484 comprising, as suitable, and in embodiments, one or more entities, such as named entities, identified from the tokens in the sliding window instance. The entities, such as named entities, may be passed as input to the relation extraction step/module 486, wherein relation extraction may be performed. In embodiments, the relation extraction step/module 486 likewise utilizes PL-Marker or other suitable modality.

A cross-page relation extraction step or module 490 may be provided downstream of the page-level ML module 480 for resolving instances of entities and/or relationship details spanning a plurality of pages of the input 476, which may be family history book. While family history books are described, it will be appreciated that the disclosure is not limited thereto, but rather the disclosure may apply to any suitable record, such as financial, legal, medical, historical, or other documents as suitable. The cross-page relation extraction step/module 490 may utilize a combination of PL-Marker and heuristics for linking entities occurring in different pages of the input 476 and thus being treated separately by the page-level ML module 480. The output of the cross-page relation extraction step/module 490 may be provided to a book-level processing and entity resolution step/module 492, which may be configured to resolve entities and relationships extracted from different pages of a family history book but which pertain to a same entity. Other heuristics may be applied, such as heuristics for joining extracted entities and relationships into a family tree structure comprising multiple generations of entities. For instance, the outputs “Jane Smith” spouse of→“John Smith” may be concatenated with additional resolved entities, such as “Robert Smith” son of→“Jane Smith”, such that Robert is shown as a descendant of John and Jane Smith in a generated pedigree structure.

In embodiments, a domain-adaptive pre-training paradigm may be adopted and utilized for improved pretraining of language models to the task(s) associated with entity extraction and relation detection in particular contexts, such as family history, and yet further within the context of, in embodiments, family history books. That is, given the observed low overlap of most-common vocabulary between disparate language domains (as low as 12% overlap in top 10K most-frequent words in documents sampled from different domains), it has been surprisingly found that adapting through pre-training a language model to the context of family-history books according to embodiments of the disclosure, significant efficiencies can be gained.

Pretraining inputs may include transcribed words, as tokens, from family history books, with pretraining objectives including, in embodiments, masked language modeling and/or next-sentence prediction. In embodiments, a language model utilized for entity extraction and relation detection in record images is RoBERTa pretrained/fine-tuned with SpERT. It has been found that this particular arrangement offers superior adaptive masking for improved language modeling.

A language model for use in embodiments of the present disclosure may be pretrained by inputting a corpus of tokens corresponding to a specified domain; in this case, the domain may be family history books, and the corpus of tokens may include words selected from a plurality of imaged and transcribed family history books. The language model may be BERT and the pretraining may extend over a plurality of epochs, e.g. 200 epochs. The accuracy of the language model in predicting next sentence may be evaluated using “perplexity” an inverse probability of the sentence predicted by the language model, where a perplexity measure is inversely proportional to the performance of the language model. To wit, the perplexity metric may be determined as a function of or based on a probability calculation, e.g. a probability of each word in a given sequence; an entropy calculation, e.g. an entropy based on the calculated probabilities as an average negative log probability of the correct next word; and a perplexity metric determined as an exponent of the average entropy.

In embodiments, fine-tuning of the language model may be performed iteratively and/or specifically to batches of family history books. That is, a subset of books of a particular batch or collection of family history books may be provided to the language model as fine-tuning data specific to the batch or collection that the subset represents, allowing the language model to dynamically be adapted to the nuances specific to particular collections of documents. Additionally, or alternatively, preprocessing steps may be performed on raw text data extracted from input images via OCR. For instance, one or more preprocessing steps that render the tokens of the OCR text data more amenable to the particulars of the language model in use may be performed. For instance, heuristics may be applied to remove artifacts from the specific document type, such as cross-page or-line hyphenations.

Thus where the OCR text data renders a name “Sam-uel” because the name “Samuel” spanned two pages or two lines, a heuristic may be employed to concatenate the hyphenated halves of the name. In other embodiments, a ML approach, such as the use of a large language model may be utilized to handle such artifacts in raw OCR data; in yet further embodiments, large language models may be provided as the language model for fine-tuning, thereby, in some situations, obviating the need for preprocessing. Further, while family history books have been described, it will be appreciated that the disclosure is not limited thereto; rather, the disclosed approach to fine-tuning a language model specific to the nuances of a particular domain of documents may be performed not only in family history books but rather in genealogy writ large and in other fields, such as medicine, law, finance, government, literature, or otherwise.

In other embodiments, a SpERT instance may be fine-tuned using the approach described above, and further using a pretrained BERT instance. It has been surprisingly found that this advantageously improves performance further.

In an embodiment, pre-processing steps may be performed to correct annotated records for training a model according to embodiments of the disclosure. For example, referring to FIG. 4D, a method 495 may include receiving input annotations, such as manual labels associated with particular record images. These may be provided in, e.g., a JSON file comprising tokens, entities, and/or relations, in addition to other meta information as suitable. The entities identified in the input JSON file may be associated with a unique identifier, such as serialized identifiers, but it has been found that these identifiers—and data related thereto—often do not appear in order, such as increasing order. A first step of the method 495 may include serializing entities such that the entities (and related data, such as relations) are in serialized, e.g. increasing, order.

A second step may include merging a maiden name into given, i.e. “first,” names, so as to make the data consistent between different batches and/or conventions. For example, it has been found that sometimes maiden names are combined into a single entity as a “given name,” whereas in other batches first names and maiden names are marked as separate entity types (e.g. “first name” and “maiden name”). In order to ensure a consistent ontology, the maiden names may be merged with given names into a consolidated “given name” entity.

A third step may include decomponentizing location entities to address inconsistencies among locations observed between different batches of annotations. Where, for example, one batch consistently marks locations as a single location but another batch consistently marks corresponding locations as granular entity subtypes such as county, city, state, and countries, the more-granular location-entity subtypes may be resolved back to single locations, with corresponding resolutions applied to corresponding relations.

Analogously, a fourth step may include correcting errors pertaining to locations and dates. For example, in some instances it has been observed that some relations are wrongly marked as birth, marriage, and/or death dates when, in fact, the relations are birth, marriage, and/or death places. These relations can be corrected by leveraging corresponding entity types.

A fifth step may include a task of leveraging entity types to ensure that arrows indicating a directionality of relation between corresponding pairs of entities are correct. It has been found that in some cases, the arrow directions between pairs of entities are inconsistent, such that a head of an arrow points to a second entity of an entity pair, with a tail of the arrow pointing to or originating from the first entity of the entity pair. This may be performed for, e.g., dates and locations relations.

A task of the fifth step may additionally, or alternatively, include updating a relation between a last occurrence of a first entity of an entity pair and a first occurrence of a second entity of an entity pair, such that the second entity can be properly linked to the first entity. This advantageously mitigates the model-confusion effects of labels being applied between the first occurrences of two entities, resulting in a long-distance relation. This distance may be alleviated, as mentioned, by updating the relation between the last occurrence of the first entity (including its mention either in its proper or common noun or pronoun forms) and the first occurrence of the second entity, and then linking the second entity to the first entity. It has been found that this reduces model confusion and improves entity-extraction and relation-detection steps during inference.

A sixth step may include converting entities to camel-case from all-caps cases, where appropriate, as it has been found that language models extract relations poorly if the entities are in caps-cases.

By providing the pre-processing method 495, entity extraction and relation detection may be improved particularly in combination with the model pipelines discussed herein.

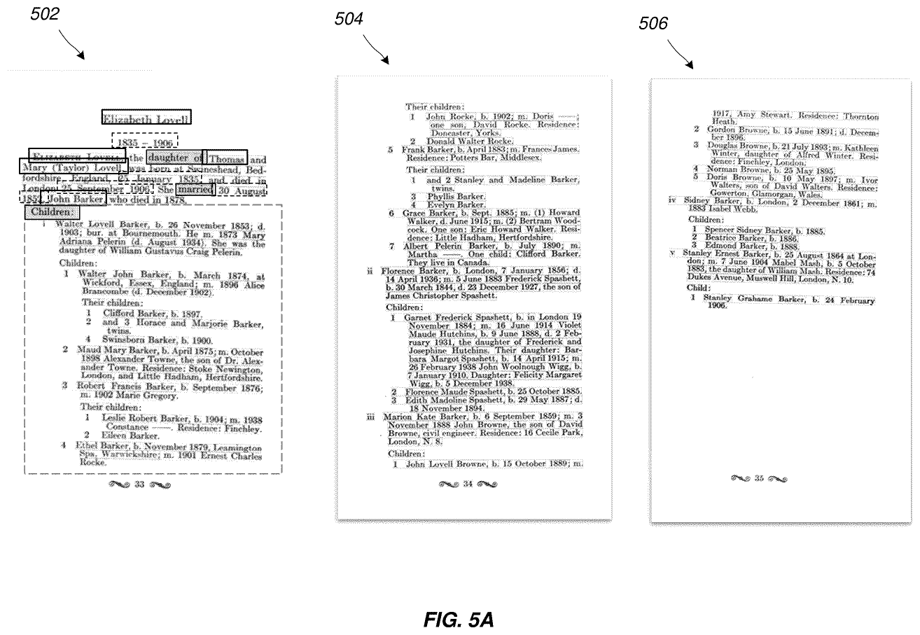

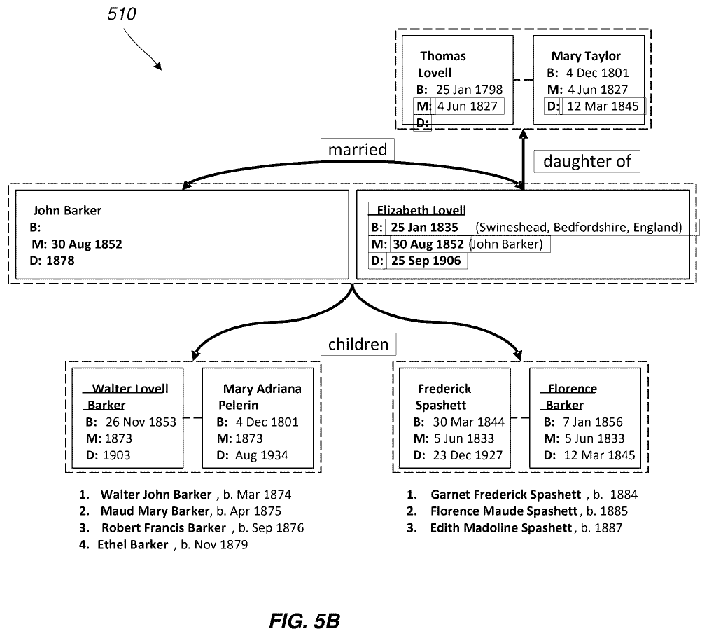

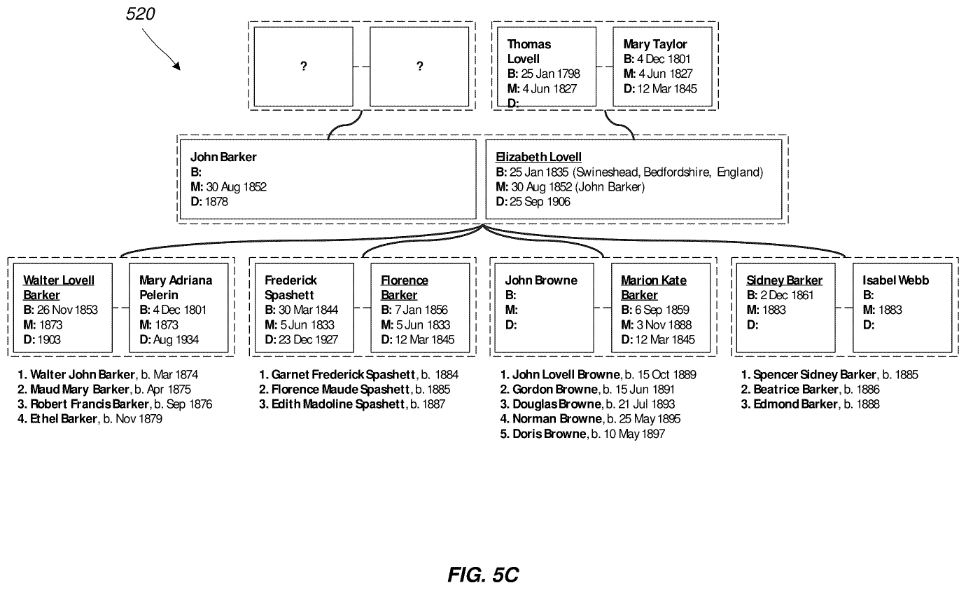

FIG. 5A shows images of a genealogical record such as a family history book including three pages (502, 504, 506). These pages may contain genealogical information about a family, including names, dates, places, and relationships. The content of the pages may further include a mix of narrative text and possibly some structured information such as lists or tables. The computing server 130 can extract entities and relationships in the family history book to construct a family tree according to the embodiments described in the present disclosure.

FIG. 5B illustrates a family history tree constructed using data extracted from page 502 of FIG. 5A. The family history tree can be a partial representation of the family structure, containing the information available on page 502. It may show a limited number of family members and their relationships, possibly spanning just one or two generations. Advantageously, the details associated with the identified entities and relationships—including birth, marriage, and death dates, and names and orders of related persons such as children—are identified from the pages 502, 504, 506 of a family history book, despite the challenging mix of narrative and structured information therein, using the embodiments of the disclosure.

FIG. 5C illustrates a more complete family history tree 520 built using data extracted from all three pages (502, 504, and 506) of FIG. 5A. The family history tree 520 is more extensive and detailed compared to the family history tree 510 of FIG. 5B. The family history tree 520 can include additional family members, more generations, and a more complex network of relationships. The family history tree 520 in FIG. 5C demonstrates the ability of the computing server 130 to integrate information across multiple pages, processing and extracting entities and relationships that may be mentioned in different pages (502, 504, and 506) of the family history book. The progression from FIG. 5B to FIG. 5C shows the importance of processing pages and content from the family history book to construct a more-complete family tree, and the computer server 130's capability to perform cross-page entity and relationship extraction.

### Machine Learning Models

In various embodiments, a wide variety of machine-learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used.

In various embodiments, the training techniques for a machine learning model may be supervised, semi-supervised, or unsupervised. In supervised learning, the machine learning models may be trained with a set of training samples that are labeled. Any one of a number of supervised learning techniques may be used to train the models. Examples include, but are not limited to, random forests and other ensemble learning techniques, support vector machines (SVM), and logistic regression. In some cases, an unsupervised learning technique may be used, where the samples used in training are not labeled. Various unsupervised learning techniques such as clustering may be used.

In some embodiments, the machine-learned model may be a large language model (LLM) that is specifically designed to generate human-like text. This machine-learned model is part of a broader category of machine-learning models known as transformer models, which allow them to understand and process a natural language such as the language that humans naturally use to communicate. LLMs are categorized as large because they have numerous parameters (billions in some cases) that they adjust during the training process. The size of these models helps them better understand and generate human-like text because they can learn from a vast amount of data, memorizing a larger amount of information about language patterns and structures.

A generative pretrained transformer (GPT) is an example of an LLM. It may be trained on diverse data sets in an unsupervised learning manner, which means no explicit instructions or labels were provided to it during the training phase. Instead, it learned patterns and relationships from the data it was trained on and used these patterns to generate text that resembles human-written content. In practice, these models take a prompt (a piece of text input) and generate a text continuation. They predict the next part of a text based on the patterns they have learned and the specific prompt provided. LLMs have the ability to generate diverse types of text in a human-like manner, ranging from simple sentences to full articles. They may be used for a variety of applications such as draft generation, brainstorming ideas, writing assistance, and even in complex tasks like generating code or translating languages.

In some embodiments, a transformer model such as PL-Marker can be used for entity extraction tasks in genealogical records. This architecture processes text using self-attention mechanisms, allowing the model to capture context and relationships effectively. The model can include an encoder stack with multiple layers, each containing self-attention and feed-forward neural networks. For entity extraction, the transformer model can be fine-tuned on genealogical data to identify and classify relevant entities like names, dates, places, and events. The PL-Marker model can build upon a pre-trained language model like BERT, further specialized for genealogical and/or historical texts. This approach can provide the model to understand the nuances of family history documents, resulting in accurate entity extraction within the processing pipeline. The output layer can be adapted to predict entity labels for each input token, optimizing the model for the specific task of identifying genealogically significant information from family history books.

In some embodiments, a transformer model such as the PL-Marker model can be used for determining relationships between extracted entities in genealogical records. The transformer model can be fine-tuned for relationship classification. The transformer model can process pairs of entities with their surrounding context, leveraging self-attention mechanisms to capture relationship nuances. The transformer model can identify relationships described across multiple sentences or paragraphs. It can be trained on genealogical data to recognize various familial and event-based relationships. The input can include text segments containing entity pairs, with special tokens marking entity positions. The output layer can classify the relationship between these pairs. The transformer model can process both the entities and their context to provide accurate relationship determinations.

In embodiments, PL-Marker or other suitable models for entity extraction and relation detection may utilize a span-representation approach that accounts for the relationships between spans of tokens or pairs of entities by strategically packing markers, associated with spans and comprising start and end token markers, in an encoder.

### Computing Machine Architecture

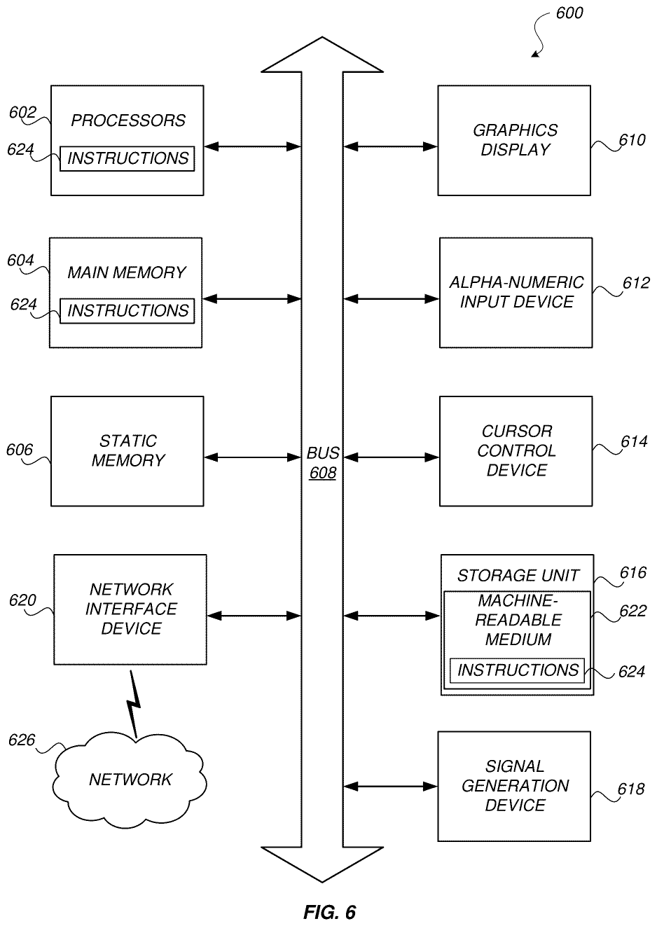

FIG. 6 is a block diagram illustrating components of an example computing machine that is capable of reading instructions from a computer-readable medium and executing them in a processor (or controller). A computer described herein may include a single computing machine shown in FIG. 6, a virtual machine, a distributed computing system that includes multiple nodes of computing machines shown in FIG. 6, or any other suitable arrangement of computing devices.

By way of example, FIG. 6 shows a diagrammatic representation of a computing machine in the example form of a computer system 600 within which instructions 624 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 6 may correspond to any software, hardware, or combined components shown in FIGS. 1 and 2, including but not limited to, the client device 110, the computing server 130, and various engines, interfaces, terminals, and machines shown in FIG. 2. While FIG. 10 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 624 that specify actions to be taken by that machine. Further, while only a single machine is illustrated, the terms “machine” and “computer” may also be taken to include any collection of machines that individually or jointly execute instructions 624 to perform any one or more of the methodologies discussed herein.

The example computer system 600 includes one or more processors 602 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 600 may also include a memory 604 that stores computer code including instructions 624 that may cause the processors 602 to perform certain actions when the instructions are executed, directly or indirectly by the processors 602. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One or more methods described herein improve the operation speed of the processor 602 and reduce the space required for the memory 604. For example, the database processing techniques and machine learning methods described herein reduce the complexity of the computation of the processors 602 by applying one or more novel techniques that simplify the steps in training, reaching convergence, and generating results of the processors 602. The algorithms described herein also reduce the size of the models and datasets to reduce the storage space requirement for memory 604.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though the specification or the claims may refer to some processes to be performed by a processor, this may be construed to include a joint operation of multiple distributed processors. In some embodiments, a computer-readable medium comprises one or more computer-readable media that, individually, together, or distributedly, comprise instructions that, when executed by one or more processors, cause the one or more processors to perform, individually, together, or distributedly, the steps of the instructions stored on the one or more computer-readable media. Similarly, a processor comprises one or more processors or processing units that, individually, together, or distributedly, perform the steps of instructions stored on a computer-readable medium. In various embodiments, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situation such as in multiple processors of a system in a chip, in Cloud computing, or in distributed computing.

The computer system 600 may include a main memory 604, and a static memory 606, which are configured to communicate with each other via a bus 608. The computer system 600 may further include a graphics display unit 610 (e.g., a plasma display panel (PDP), a liquid crystal display (LCD), a projector, or a cathode ray tube (CRT)). The graphics display unit 610, controlled by the processor 602, displays a graphical user interface (GUI) to display one or more results and data generated by the processes described herein. The computer system 600 may also include an alphanumeric input device 612 (e.g., a keyboard), a cursor control device 614 (e.g., a mouse, a trackball, a joystick, a motion sensor, or other pointing instruments), a storage unit 616 (a hard drive, a solid-state drive, a hybrid drive, a memory disk, etc.), a signal generation device 618 (e.g., a speaker), and a network interface device 620, which also are configured to communicate via the bus 608.

The storage unit 616 includes a computer-readable medium 622 on which is stored instructions 624 embodying any one or more of the methodologies or functions described herein. The instructions 624 may also reside, completely or at least partially, within the main memory 604 or within the processor 602 (e.g., within a processor's cache memory) during execution thereof by the computer system 600, the main memory 604 and the processor 602 also constituting computer-readable media. The instructions 624 may be transmitted or received over a network 626 via the network interface device 620.

While computer-readable medium 622 is shown in an example embodiment to be a single medium, the term “computer-readable medium” should be taken to include a single medium or multiple media (e.g., a centralized or distributed database, or associated caches and servers) able to store instructions (e.g., instructions 624). The computer-readable medium may include any medium that is capable of storing instructions (e.g., instructions 624) for execution by the processors (e.g., processors 602) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, or storage medium, as well. The dependencies or references in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

The following applications are incorporated by reference in their entirety for all purposes: (1) U.S. Pat. No. 10,679,729, entitled “Haplotype Phasing Models,” granted on Jun. 9, 2020, (2) U.S. Pat. No. 10,223,498, entitled “Discovering Population Structure from Patterns of Identity-By-Descent,” granted on Mar. 5, 2019, (3) U.S. Pat. No. 10,720,229, entitled “Reducing Error in Predicted Genetic Relationships,” granted on Jul. 21, 2020, (4) U.S. Pat. No. 10,558,930, entitled “Local Genetic Ethnicity Determination System,” granted on Feb. 11, 2020, (5) U.S. Pat. No. 10,114,922, entitled “Identifying Ancestral Relationships Using a Continuous Stream of Input,” granted on Oct. 30, 2018, (6) U.S. Pat. No. 11,429,615, entitled “Linking Individual Datasets to a Database,” granted on Aug. 30, 2022, (7) U.S. Pat. No. 10,692,587, entitled “Global Ancestry Determination System,” granted on Jun. 23, 2020, and (8) U.S. Patent Application Publication No. US 2021/0034647, entitled “Clustering of Matched Segments to Determine Linkage of Dataset in a Database,” published on Feb. 4, 2021.

What is claimed is:

1. A computer-implemented method comprising:
extracting, utilizing an entity extraction machine learning model to perform in-page entity extraction, a first entity from a genealogical record by using a sliding window of the entity extraction machine learning model to analyze a first set of tokens on a first page of the genealogical record according to a predetermined token length;
extracting, utilizing the entity extraction machine learning model to perform cross-page entity extraction, a second entity from the genealogical record by shifting the sliding window to analyze a second set of tokens on a second page adjacent to the first page of the genealogical record;
determining entity relationships for the first entity and the second entity utilizing a relationship determination machine learning model; and
generating a graph data structure comprising nodes representing the first entity and the second entity, and further comprising edges representing the entity relationships for the first entity and the second entity.

2. The computer-implemented method of claim 1, wherein determining the entity relationships for the first entity and the second entity comprises generating reconciled entity relationships by disambiguating duplicate entities corresponding to the first entity or of the second entity determined to be mentioned a plurality of times.

3. The computer-implemented method of claim 1, further comprising:
segmenting, utilizing a page segmentation model, the first page and the second page of the genealogical record into text blocks based on visual characteristics and position of text of the genealogical record; and
identifying related text portions from the first page and the second page of the genealogical record based on the text blocks.

4. The computer-implemented method of claim 3, further comprising:
extracting, utilizing the entity extraction machine learning model to perform cross-page entity extraction, a third entity from the first page of the genealogical record and a fourth entity from the second page of the genealogical record based on the related text portions; and
determining additional entity relationships for the first entity, second entity, third entity, and the fourth entity utilizing the relationship determination machine learning model.

5. The computer-implemented method of claim 4, further comprising generating a modified graph data structure comprising additional nodes representing the third entity and the fourth entity, and further comprising additional edges representing the additional entity relationships.

6. The computer-implemented method of claim 1, further comprising:
generating normalized biographical data by standardizing biographical data extracted from the genealogical record into a consistent format; and
associating the normalized biographical data with at least one node of the nodes comprised in the graph data structure.

7. The computer-implemented method of claim 1, wherein extracting the second entity from the genealogical record comprises extracting the second entity from the second page adjacent to the first page, wherein the second page is a nonconsecutive page to the first page.

8. A system comprising:
at least one processor; and
at least one non-transitory computer-readable storage medium storing instructions that, when executed by the at least one processor, cause the system to:
extract, utilizing an entity extraction machine learning model to perform in-page entity extraction, a first entity from a genealogical record by using a sliding window of the entity extraction machine learning model to analyze a first set of tokens on a first page of the genealogical record according to a predetermined token length;
extract, utilizing the entity extraction machine learning model to perform cross-page entity extraction, a second entity from the genealogical record by shifting the sliding window to analyze a second set of tokens on a second page adjacent to the first page of the genealogical record;
determine entity relationships for the first entity and the second entity utilizing a relationship determination machine learning model; and
generate a graph data structure comprising nodes representing the first entity and the second entity, and further comprising edges representing the entity relationships for the first entity and the second entity.

9. The system of claim 8, wherein determining the entity relationships for the first entity and the second entity comprises generating reconciled entity relationships by disambiguating duplicate entities corresponding to the first entity or of the second entity determined to be mentioned a plurality of times.

10. The system of claim 8, further comprising instructions that, when executed by the at least one processor, cause the system to:
segment, utilizing a page segmentation model, the first page and the second page of the genealogical record into text blocks based on visual characteristics and position of text of the genealogical record; and
identify related text portions from the first page and the second page of the genealogical record based on the text blocks.

11. The system of claim 10, further comprising instructions that, when executed by the at least one processor, cause the system to:
extract, utilizing the entity extraction machine learning model to perform cross-page entity extraction, a third entity from the first page of the genealogical record and a fourth entity from the second page of the genealogical record based on the related text portions; and
determine additional entity relationships for the first entity, second entity, third entity, and the fourth entity utilizing the relationship determination machine learning model.

12. The system of claim 11, further comprising instructions that, when executed by the at least one processor, cause the system to generate a modified graph data structure comprising additional nodes representing the third entity and the fourth entity, and further comprising additional edges representing the additional entity relationships.

13. The system of claim 8, further comprising instructions that, when executed by the at least one processor, cause the system to:
generate normalized biographical data by standardizing biographical data extracted from the genealogical record into a consistent format; and
associate the normalized biographical data with at least one node of the nodes comprised in the graph data structure.

14. The system of claim 8, further comprising instructions that, when executed by the at least one processor, cause the system to extract the second entity from the genealogical record by extracting the second entity from the second page adjacent to the first page, wherein the second page is a nonconsecutive page to the first page.

15. A non-transitory computer-readable medium storing instructions that, when executed by at least one processor, cause a computing device to:
extract, utilizing an entity extraction machine learning model to perform in-page entity extraction, a first entity from a genealogical record by using a sliding window of the entity extraction machine learning model to analyze a first set of tokens on a first page of the genealogical record according to a predetermined token length;
extract, utilizing the entity extraction machine learning model to perform cross-page entity extraction, a second entity from the genealogical record by shifting the sliding window to analyze a second set of tokens on a second page adjacent to the first page of the genealogical record;
determine entity relationships for the first entity and the second entity utilizing a relationship determination machine learning model; and
generate a graph data structure comprising nodes representing the first entity and the second entity, and further comprising edges representing the entity relationships for the first entity and the second entity.

16. The non-transitory computer-readable medium of claim 15, wherein determining the entity relationships for the first entity and the second entity comprises generating reconciled entity relationships by disambiguating duplicate entities corresponding to the first entity or of the second entity determined to be mentioned a plurality of times.

17. The non-transitory computer-readable medium of claim 15, further comprising instructions that, when executed by the at least one processor, cause the computing device to:
segment, utilizing a page segmentation model, the first page and the second page of the genealogical record into text blocks based on visual characteristics and position of text of the genealogical record; and
identify related text portions from the first page and the second page of the genealogical record based on the text blocks.

18. The non-transitory computer-readable medium of claim 17, further comprising instructions that, when executed by the at least one processor, cause the computing device to:
extract, utilizing the entity extraction machine learning model to perform cross-page entity extraction, a third entity from the first page of the genealogical record and a fourth entity from the second page of the genealogical record based on the related text portions; and
determine additional entity relationships for the first entity, second entity, third entity, and the fourth entity utilizing the relationship determination machine learning model.

19. The non-transitory computer-readable medium of claim 18, further comprising instructions that, when executed by the at least one processor, cause the computing device to generate a modified graph data structure comprising additional nodes representing the third entity and the fourth entity, and further comprising additional edges representing the additional entity relationships.

20. The non-transitory computer-readable medium of claim 15, further comprising instructions that, when executed by the at least one processor, cause the computing device to extract the second entity from the genealogical record by extracting the second entity from the second page adjacent to the first page, wherein the second page is a nonconsecutive page to the first page.
